(19) United States
(12) Patent Application Publication
(10) Pub. No.: US 2021/0377267 A1
(43) Pub. Date: Dec. 2, 2021

(54) INFORMATION PROCESSING APPARATUS AND NETWORK DEVICE

(71) Applicant: FUJIFILM BUSINESS INNOVATION CORP., Tokyo (JP)

(72) Inventors: Dawei YANG, Kanagawa (JP); Wenjin ZHANG, Kanagawa (JP)

(73) Assignee: FUJIFILM BUSINESS INNOVATION CORP., Tokyo (JP)

(21) Appl. No.: 17/123,834

(22) Filed: Dec. 16, 2020

(30) Foreign Application Priority Data
May 28, 2020 (JP) 2020-093610

(51) Int. Cl. H04L 29/06; H04L 12/58; G06Q 10/02

(52) U.S. Cl. CPC H04L 63/0876; H04L 63/108; G06Q 10/02; H04L 63/101; H04L 51/24; H04L 63/102

(57) ABSTRACT

An information processing apparatus includes a processor configured to receive first information for identifying a network device selected to be used by a user and second information for identifying the user from a terminal of the user each time the network device is used, acquire, from a system of a business operator to which the user belongs, operational setting to be applied to the user who is identified by the second information and uses the network device identified by the first information, and notify the network device of the operational setting.

### CROSS-REFERENCE TO RELATED APPLICATIONS

This application is based on and claims priority under 35 USC 119 from Japanese Patent Application No. 2020-093610 filed May 28, 2020.

### BACKGROUND

### (i) Technical Field

The present disclosure relates to an information processing apparatus and a network device.

### (ii) Related Art

There is an increasing demand for sharable offices (hereinafter referred to as “shared offices”) along with the spread of a variety of ways of working. Fixtures shared by users are installed in the shared offices. One example of the fixtures is an image forming apparatus that provides a plurality of functions such as printing, copying, faxing, and scanning.

An example of such an apparatus is described in Japanese Unexamined Patent Application Publication No. 2017-184286.

### SUMMARY

Users of the shared offices which are rented by the month or used on a metered system change frequently compared to the existing offices which are rented by the year. Therefore, it is difficult to register beforehand information on the users, operational settings, etc. in all the network devices such as image forming apparatuses in the shared offices. As a result, the users are required to individually input operational settings etc. each time the users use the network devices, which is burdensome to the users.

In addition, the network devices in the shared offices are operated by unspecified users. Therefore, there are some clients who do not wish that information on the users or information on operational settings etc. remain in the shared offices.

Aspects of non-limiting embodiments of the present disclosure relate to reducing the trouble of inputting operational settings and improving security compared to the case where information on the users and operational settings are managed on the side of the shared office in preparation for common use of the network devices by unspecified users.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to receive first information for identifying a network device selected to be used by a user and second information for identifying the user from a terminal of the user each time the network device is used, acquire, from a system of a business operator to which the user belongs, operational setting to be applied to the user who is identified by the second information and uses the network device identified by the first information, and notify the network device of the operational setting.

### BRIEF DESCRIPTION OF THE DRAWINGS

An exemplary embodiment of the present disclosure will be described in detail based on the following figures, wherein:

FIG. 1 illustrates an example of the configuration of a system that is used to manage shared offices;

FIG. 2 illustrates an example of the configuration of an image forming apparatus;

FIG. 3 illustrates a part of data stored in a storage device;

FIG. 4 illustrates an example of the configuration of an intermediary agent server;

FIG. 5 illustrates a part of data stored in the storage device;

FIG. 6A illustrates an example of a table that is stored in the storage device and that is used to manage the shared offices;

FIG. 6B illustrates an example of a table that is stored in the storage device and that is used to manage companies to which users belong;

FIG. 7A illustrates an example of data stored in the storage device, illustrating an example of data on user authentication information;

FIG. 7B illustrates an example of data stored in the storage device, illustrating an example of data on detailed use information;

FIG. 8 illustrates an example of the configuration of a management server of a company to which a user belongs;

FIG. 9 illustrates a part of data stored in the storage device;

FIG. 10A illustrates an example of data managed by the management server, illustrating an example of data on user information;

FIG. 10B illustrates an example of data managed by the management server, illustrating an example of data on setting information and policy information stored for each user;

FIGS. 11A and 11B illustrate the flow of processing operation executed by a management system;

FIG. 12 illustrates an example of a screen displayed on a display unit of the image forming apparatus in the case where a user who desires to use a shared office performs a specific operation;

FIG. 13 illustrates an example of a screen displayed on a portable terminal in the case where the user starts a dedicated app;

FIG. 14 illustrates an example of a screen displayed on the portable terminal in the case where a barcode is captured;

FIG. 15 illustrates an example of a screen displayed in the case where the portable terminal receives a use right code from the intermediary agent server;

FIG. 16 illustrates an example of a screen displayed on the display unit of the image forming apparatus; and

FIG. 17 illustrates an example of a screen displayed on the display unit of the image forming apparatus after the start of use by the user.

### DETAILED DESCRIPTION

An exemplary embodiment will be described in detail below with reference to the accompanying drawings.

### <System Configuration>

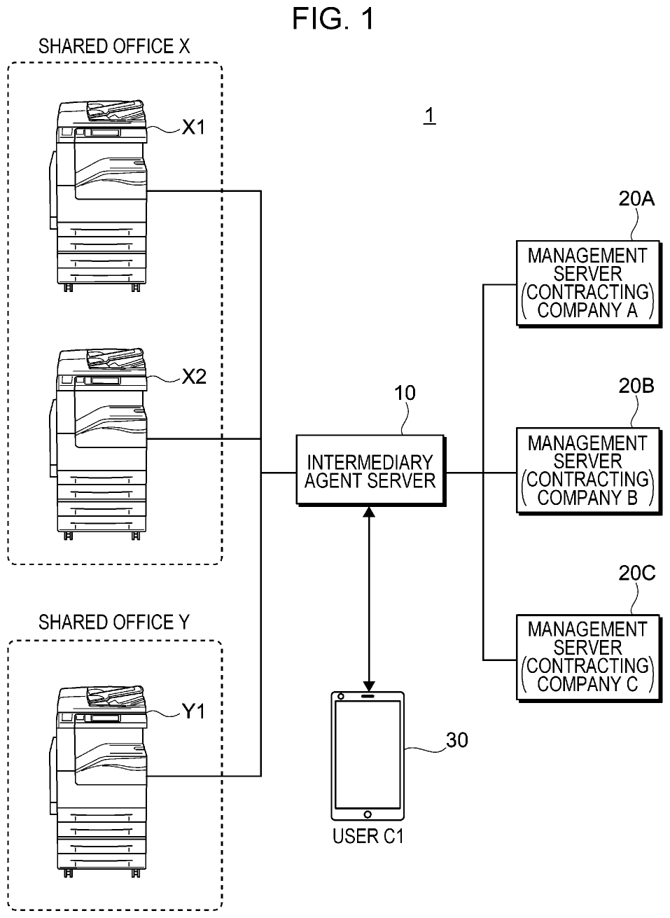

FIG. 1 illustrates an example of the configuration of a system that is used to manage shared offices. A management system 1 illustrated in FIG. 1 is constituted as a cloud system, for example.

The management system 1 is composed of a server (hereinafter referred to as an “intermediary agent server”) 10 operated by an intermediary agent that provides a management service, management servers 20A, 20B, and 20C of companies (hereinafter also referred to as “contracting companies”) to which users who use the shared offices belong, a portable terminal 30 carried by a user, and image forming apparatuses X1, X2, and Y1 shared by the users of the shared offices.

In the case of the management system 1 illustrated in FIG. 1, there are two shared offices, namely a shared office X and a shared office Y. However, the number of shared offices may be one or three or more. In the following, the shared office X and the shared office Y are referred to as “shared offices” unless such shared offices are differentiated from each other.

In the case of the present exemplary embodiment, a business operator that operates the shared office X and a business operator that operates the shared office Y are different from each other. However, the business operators that operate the shared office X and the shared office Y may be the same as each other. In that case, the shared office X and the shared office Y are considered as different sites of an identical business operator.

In the case of the present exemplary embodiment, in addition, the business operators that operate the shared offices and the intermediary agent that provides the management service are different from each other. However, a part of the business operators that operate the shared offices and the intermediary agent that provides the management service may be the same as each other.

In the case of the present exemplary embodiment, the intermediary agent that provides the management service and contracting companies A, B, and C are different from each other. In the following, the contracting company A, the contracting company B, and the contracting company C are referred to as “contracting companies” unless such contracting companies are differentiated from each other. The contracting companies are examples of business operators to which the users belong.

In the case of the present exemplary embodiment, the business operators that operate the shared offices and the companies to which the users who use the shared offices belong are different from each other. However, it is possible for a part of the contracting companies to provide a part of their own offices to other business operators as a shared office.

In the case of FIG. 1, two image forming apparatuses are disposed in the shared office X, and one image forming apparatus is disposed in the shared office Y. As a matter of course, the number of image forming apparatuses disposed in each shared office may be determined as desired, and may be three or more.

The image forming apparatuses according to the present exemplary embodiment are connected to the intermediary agent server 10 through a network. In this sense, the image forming apparatuses are examples of a network device. The network is assumed to be the Internet, for example. However, the image forming apparatuses in the shared offices are connected to the Internet by way of a local area network (LAN).

The image forming apparatuses which are used in the present exemplary embodiment have a plurality of functions such as printing, copying, faxing, and scanning, as with image forming apparatuses that are used by the users at the contracting companies. The image forming apparatuses assumed for the present exemplary embodiment are also referred to as “multi-function devices”.

In the case of the present exemplary embodiment, the image forming apparatuses disposed in the shared offices have functions that are the same as or equivalent to those of the image forming apparatuses disposed at the companies to which the users belong. It is desirable that the image forming apparatuses disposed in the shared offices should be the same as the image forming apparatuses disposed at the companies to which the users belong. The image forming apparatuses disposed in the shared offices and the image forming apparatuses disposed at the companies to which the users belong may be image forming apparatuses having equivalent functions and manufactured by the same manufacturer.

The image forming apparatuses which are used in the management system 1 according to the present exemplary embodiment may include an image forming apparatus manufactured by a different manufacturer. For example, it is not necessary that the management system 1 should be composed of image forming apparatuses manufactured by a single manufacturer if the image forming apparatuses disposed in the shared offices and the intermediary agent server 10 have a function of securing compatibility for settings related to equivalent functions.

The intermediary agent server 10 provides a function of providing information on a user and operational settings that are peculiar to the user to a subject image forming apparatus in a shared office each time the user uses the image forming apparatus.

In addition, information on a user etc. provided to an image forming apparatus in a shared office is deleted from the image forming apparatus each time the use is ended. The term “use” here may mean each time of use or each period of use.

In the case of the present exemplary embodiment, information on a user etc. is deleted from the intermediary agent server 10 at the termination of a period for which use of a shared office by the user is permitted.

In the case of the present exemplary embodiment, communication with the intermediary agent server 10 is required for a user to use an image forming apparatus in a shared office. By using this communication, the intermediary agent server 10 also manages the number of times of use of the image forming apparatus disposed in the shared office and a valid period for which the image forming apparatus is usable.

The intermediary agent server 10 also has a function of acquiring information on the details of use of an image forming apparatus in a shared office by users from the image forming apparatus each time the image forming apparatus is used, summarizing such information, and notifying the company to which the users belong.

The notification of the information on the details of use from the intermediary agent server 10 to the contracting company is executed each time use by the users is ended, at periods determined in advance, at times determined in advance, and upon request from the contracting company, for example.

While one intermediary agent server 10 is provided in the case of FIG. 1, the intermediary agent server 10 may be implemented by a plurality of servers disposed in a distributed manner on the cloud. The intermediary agent server 10 is an example of the information processing apparatus.

The management servers 20A, 20B, and 20C are severs disposed in companies that contract with the intermediary agent for the management service for the shared offices. In the following, the management servers 20A, 20B, and 20C are referred to as “management servers” unless such management servers are differentiated from each other. The management servers are connected to the intermediary agent server 10 via the Internet.

The management servers manage user information including information on whether or not individual users who are employees are allowed to use the shared offices and the valid period, operational settings of the image forming apparatuses corresponding to the users, and constraints (hereinafter also referred to as “policy information”) on settings determined by the contracting companies. In the case of the present exemplary embodiment, only the contracting companies manage the user information, the operational settings, and operational constraints.

It is not necessary that the management servers should be on-premise servers, and the management servers may be cloud servers.

The portable terminal 30 is an information terminal carried by a user who uses a shared office. The portable terminal 30 illustrated in FIG. 1 is an example of an information terminal carried by a user Cl of the contracting company C.

In the example in FIG. 1, the portable terminal 30 is a smartphone. However, the portable terminal 30 may be a tablet terminal, a cellular phone, or a wearable terminal that includes a display section and a camera.

While one portable terminal 30 is illustrated in FIG. 1, a plurality of portable terminals 30 are actually used. A plurality of portable terminals 30 are used for each of the contracting companies A, B, and C, for example.

In the case of the present exemplary embodiment, the portable terminal 30 is used to notify the intermediary agent server 10 of connection between the portable terminal 30 itself and a specific image forming apparatus that starts being used in a shared office. The portable terminal 30 is an example of a terminal of the user.

<Configuration of Image Forming Apparatus>

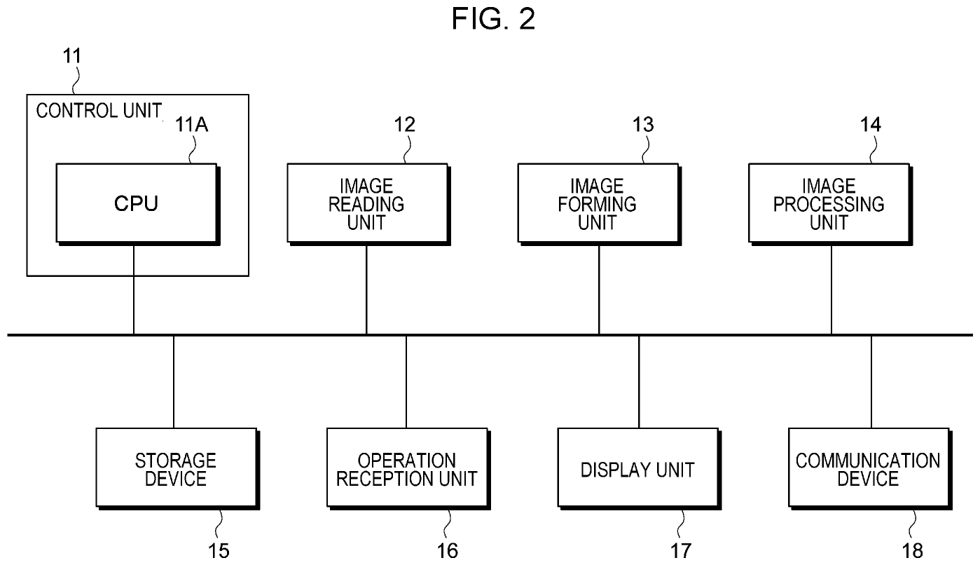

FIG. 2 illustrates an example of the configuration of the image forming apparatus.

The image forming apparatus includes: a control unit 11 that controls operation of the entire apparatus; an image reading unit 12 that reads an image of a document; an image forming unit 13 that forms an image on paper as an example of a recording medium; an image processing unit 14 that performs processing such as color correction and tone correction on image data; a storage device 15 that stores image data etc.; an operation reception unit 16 that receives an operation by a user; a display unit 17 that is used to display a user interface screen etc.; and a communication device 18 that achieves communication via a telephone line, a local area network (LAN) cable, etc. The control unit 11 and the other processing sections are connected to each other using a signal line or a bus.

The control unit 11 includes a central processing unit (CPU) 11A, a read only memory (ROM) that stores firmware, a basic input output system (BIOS), etc., and a random access memory (RAM) that is used as a work area. The control unit 11 functions as a so-called computer. The CPU 11A is an example of a processor.

The image reading unit 12 is a so-called scanner, and supports both a mode for reading an image from a document in a stationary state and a mode for reading an image from a document being conveyed.

The image forming unit 13 is a unit that forms an image on a recording medium such as paper, and includes a mechanism corresponding to the forming system. Examples of a recording material include toner and ink.

The image processing unit 14 is constituted of a dedicated processor, a processing circuit, etc. for processing image data.

The storage device 15 is constituted of a hard disk device (HDD) or a semiconductor memory, for example. The storage device 15 stores image data read through the image reading unit 12, document data and image data received through communication with an external device, FAX data received through facsimile communication, information for identifying the image forming apparatus, user information and operational setting information received from the intermediary agent server 10 (see FIG. 1), etc.

The operation reception unit 16 is constituted of a film-like touch sensor disposed on a surface of the display unit 17, switches, buttons, etc.

The display unit 17 is constituted of a liquid crystal display or an organic electro-luminescence (EL) display, for example.

The communication device 18 is constituted of a communication interface that conforms to various types of standards.

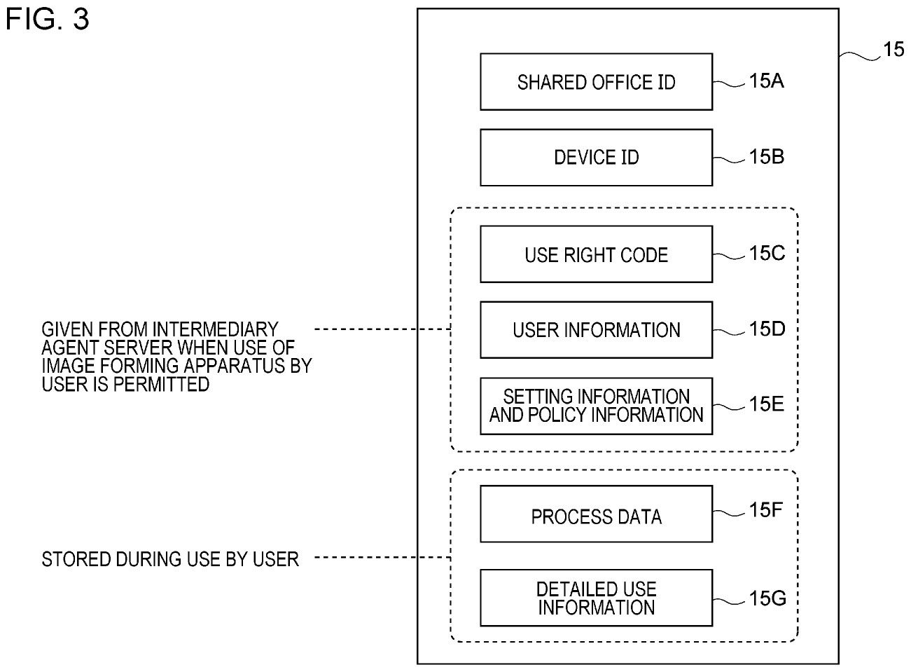

FIG. 3 illustrates a part of data stored in the storage device 15. FIG. 3 illustrates data associated with the management service for a shared office.

Among the data illustrated in FIG. 3, a shared office identification (ID) 15A and a device ID 15B are stored in the storage device 15 irrespective of use by users.

The shared office ID is information for identification allocated to the shared office as a subject for the management service. The device ID is information for identification allocated to an image forming apparatus in the shared office.

A use right code 15C is information issued for the user who has been successfully authenticated in the case where use by the user who attempts to operate the image forming apparatus is permitted. The use right code 15C is issued each time the user requests use of the image forming apparatus, for example. In the case of the present exemplary embodiment, the use right code 15C is issued by the intermediary agent server 10.

The use right code 15C is input by the user who requests use of the image forming apparatus, and stored in the storage device 15. The use right code 15C is deleted from the storage device 15 after use of the image forming apparatus by the user is terminated. The use right code 15C is an example of third information.

User information 15D is information managed by the company to which the user belongs, and includes information as to whether or not use of the shared office is allowed and a valid period for which use of the shared office is permitted. The user information 15D is given from the company to which the user belongs by way of the intermediary agent server 10 in the case where use of the image forming apparatus by the user who attempts to operate the image forming apparatus is permitted. The user information 15D is also deleted from the storage device 15 after use of the image forming apparatus by the user is terminated.

Setting information and policy information 15E is also information managed by the company to which the user belongs, and includes information on operational settings used by the user at the company and information on operational constraints imposed by the contracting company.

The setting information and policy information 15E is also given from the company to which the user belongs by way of the intermediary agent server 10 in the case where use of the image forming apparatus by the user who attempts to operate the image forming apparatus is permitted. The setting information and policy information 15E is also deleted from the storage device 15 after use of the image forming apparatus by the user is terminated.

Process data 15F are document data or image data that are used by the user who is permitted to use the image forming apparatus. Such data are an example of associated information. The process data 15F are also deleted from the storage device 15 after use of the image forming apparatus by the user is terminated.

Detailed use information 15G is information (hereinafter also referred to as a “use log”) that records operations by the user during use of the image forming apparatus, the content of processes based on the operations, etc. The detailed use information 15G is used for the company to which the user belongs to manage a situation of use of the image forming apparatus disposed in the shared office by the user. In the case of the present exemplary embodiment, the detailed use information 15G is deleted after the company to which the user belongs is notified.

<Intermediary Agent Server>

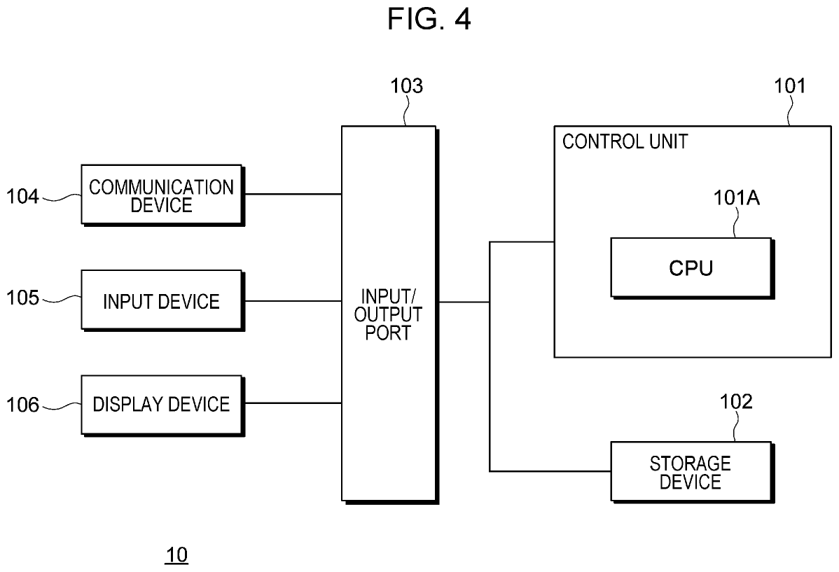

FIG. 4 illustrates an example of the configuration of the intermediary agent server 10.

The intermediary agent server 10 includes a control unit 101 that controls operation of the entire device, a storage device 102 that stores management data for the shared offices etc., an input/output port 103, a communication device 104, an input device 105, and a display device 106.

The control unit 101 includes a CPU 101A, a ROM that stores a BIOS etc., and a RAM that is used as a work area. The control unit 101 functions as a so-called computer. The CPU 101A is an example of a processor.

The storage device 102 is constituted of a hard disk device or a semiconductor memory, for example. The storage device 102 also stores an operation system and other programs, besides the management data.

Examples of the input device 105 include a keyboard and a mouse.

Examples of the display device 106 include a liquid crystal display and an organic electro-luminescence (EL) display. The display device 106 is externally attached as necessary.

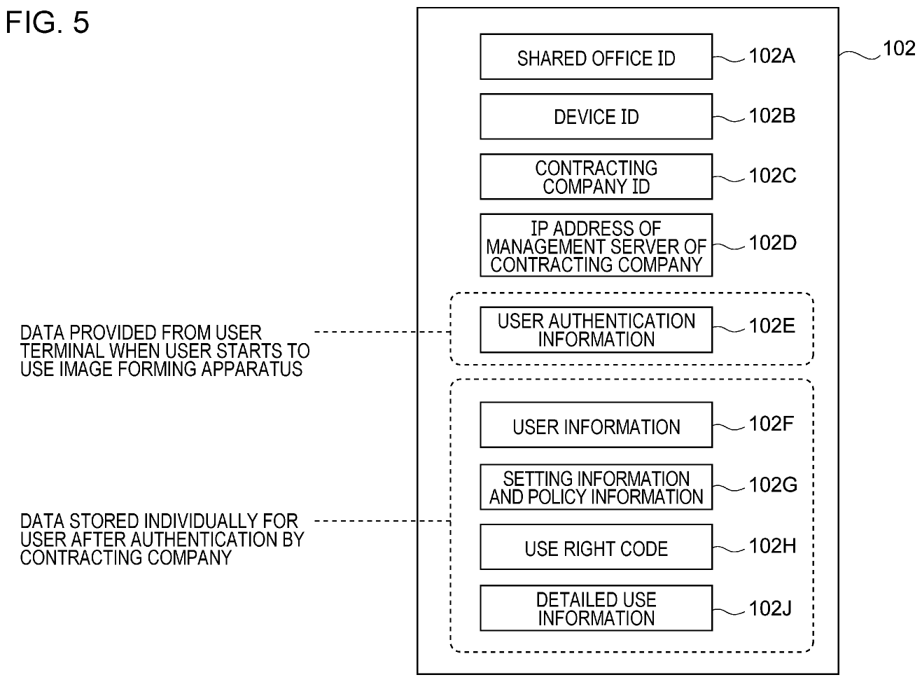

FIG. 5 illustrates a part of data stored in the storage device 102. FIG. 5 illustrates data associated with the management service for the shared office.

Among the data illustrated in FIG. 5, a shared office ID 102A, a device ID 102B of an image forming apparatus disposed in the shared office, a contracting company ID 102C, and an IP address 102D of a management server of the contracting company are registered in the storage device 102 irrespective of use by users.

The shared office ID is information for identification allocated to the shared office as a subject for the management service. The shared office ID 102A and the device ID 102B are examples of first information.

The device ID of an image forming apparatus is information for identification allocated to the image forming apparatus disposed in the shared office as a subject for the management service.

The contracting company ID is information for identification allocated to the contracting company which uses the management service.

The IP address of a management server is used in the case where the intermediary agent server 10 accesses the management server 20 for user authentication or in the case where the detailed use information acquired for each user is uploaded to the management server 20. A universal resource locator (URL) may be used in place of the IP address.

User authentication information 102E is information sent from the portable terminal 30 in the case where the user desires to use the image forming apparatus. The user authentication information 102E is stored in the storage device 102 only in the case where user authentication is requested from the company to which the user belongs. Thus, the user authentication information 102E is deleted from the storage device 102 after authentication is finished. The user authentication information 102E is an example of second information.

User information 102F is information sent from the management server 20 of the company to which the user belongs after authentication by the contracting company. The user information 102F is also deleted from the storage device 102 after use of the image forming apparatus by the user is terminated.

The setting information and policy information 102G is also information sent from the management server 20 after authentication by the company to which the user belongs. The setting information and policy information 102G is also deleted from the storage device 102 after use of the image forming apparatus by the user is terminated.

The use right code 102H is information sent from the management server 20 after authentication by the company to which the user belongs. The use right code 102H is used, in the case where the user starts to use the image forming apparatus, for the purpose of confirming that the user has the right to use the subject image forming apparatus. The use right code 102H is also deleted from the storage device 102 after use of the image forming apparatus by the user is terminated.

Detailed use information 102J is a use log that records operations by the user during use of the image forming apparatus, the content of processes based on the operations, etc. The detailed use information 102J is deleted from the storage device 102 after being provided to the contracting company to which the user belongs.

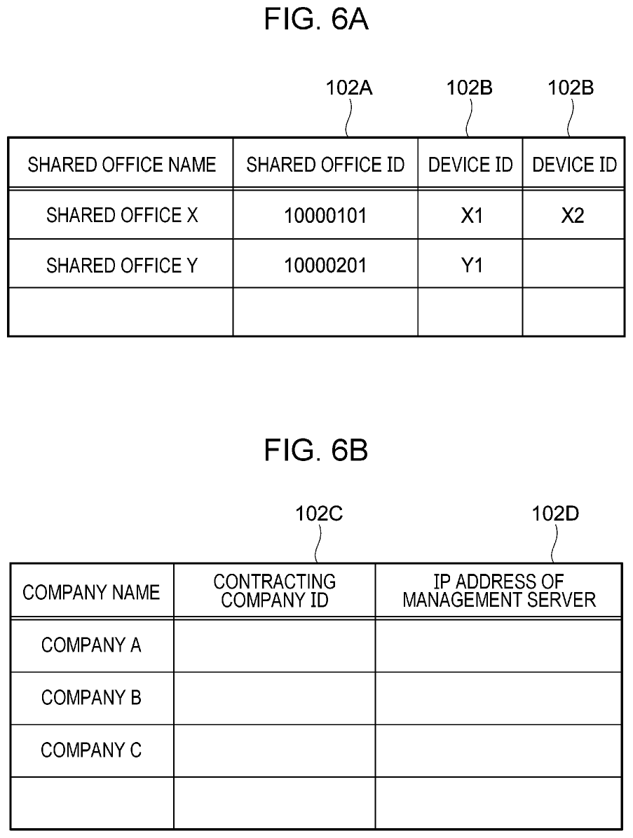

FIGS. 6A and 6B each illustrate an example of a table stored in the storage device 102. FIG. 6A illustrates a table that is used to manage the shared offices. FIG. 6B illustrates a table that is used to manage the companies to which the users belong.

As illustrated in FIGS. 6A and 6B, the device ID 102B is managed in connection with the shared office ID 102A. In the case of the present exemplary embodiment, two image forming apparatuses to be shared by the users are disposed in the shared office X, and thus the shared office X is connected with two device IDs.

The companies to which the users belong are managed in connection with the contracting company ID 102C and the IP address 102D of the management server 20.

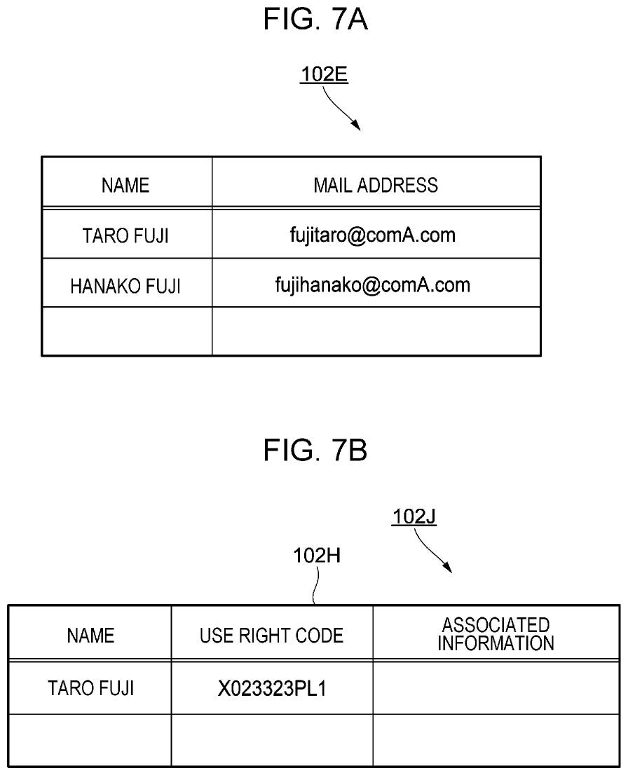

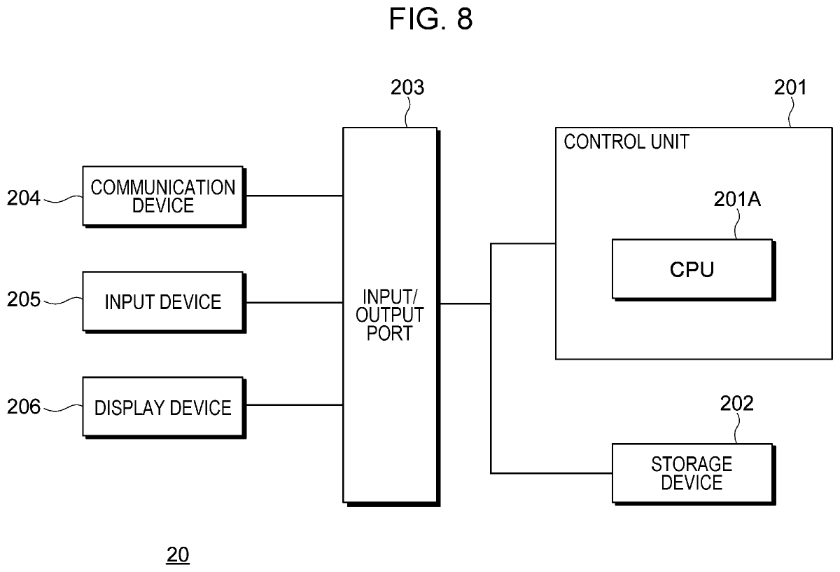

FIGS. 7A and 7B each illustrate an example of data stored in the storage device 102. FIG. 7A illustrates an example of data on the user authentication information 102E. FIG. 7B illustrates an example of data on the detailed use information 102J.

The user authentication information 102E is data given from the portable terminal 30 (see FIG. 1) carried by the user. The user authentication information 102E indicated in FIG. 7 is composed of the names and the mail addresses of the users. However, it is only necessary that the user authentication information 102E should include information that is used for authentication by the companies to which the users belong, which is not limited to the names and the mail addresses. For example, the user authentication information 102E may include the staff numbers and information on organizations to which the users belong. The mail addresses are also used for communication with the portable terminal 30.

The detailed use information 102J is composed of the name of the user, the use right code 102H, and associated information. The associated information includes operations during use of the image forming apparatus by the user, the content of processes based on the operations, etc. The use right code 102H is information that connects a specific image forming apparatus in the shared office and the user with each other.

<Contracting Company Server>

FIG. 8 illustrates an example of the configuration of the management server 20 of the company to which the user belongs.

The management server 20 includes a control unit 201 that controls operation of the entire device, a storage device 202 that stores information on staff that belong to the company etc., an input/output port 203, a communication device 204, an input device 205, and a display device 206.

The control unit 201 includes a CPU 201A, a ROM that stores a BIOS etc., and a RAM that is used as a work area. The control unit 201 functions as a so-called computer. The CPU 201A is an example of a processor.

The storage device 202 is constituted of a hard disk device or a semiconductor memory, for example. The storage device 202 also stores an operation system and other programs, besides the management data. The management data includes the user information and the setting information and policy information discussed earlier.

Examples of the input device 205 include a keyboard and a mouse.

Examples of the display device 206 include a liquid crystal display and an organic EL display. The display device 206 is externally attached as necessary.

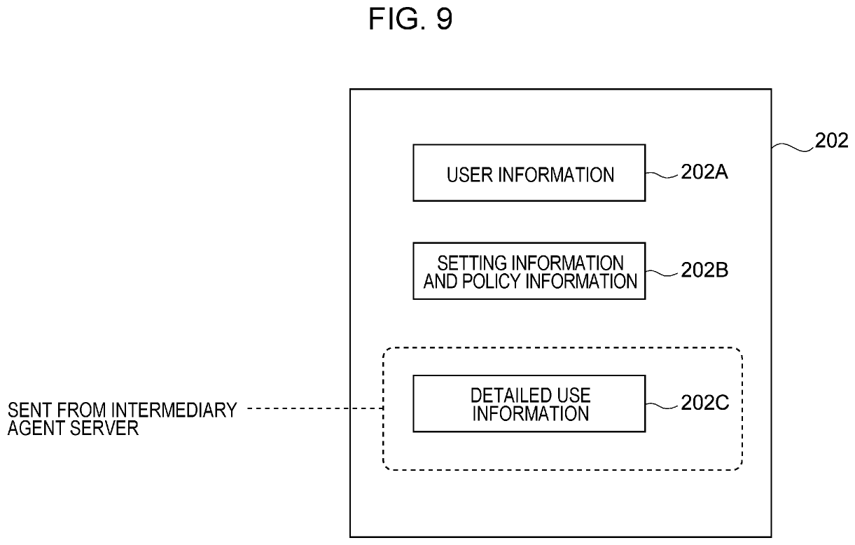

FIG. 9 illustrates a part of data stored in the storage device 202. FIG. 9 illustrates data associated with the management service for the shared office.

Among the data illustrated in FIG. 9, user information 202A and setting information and policy information 202B is data that are used by the company to which the user belongs to manage the employees, and is stored in the storage device 202 irrespective of use by the user. Detailed use information 202C corresponding to the use log is sent from the intermediary agent server 10 after use of the image forming apparatus by the users is terminated.

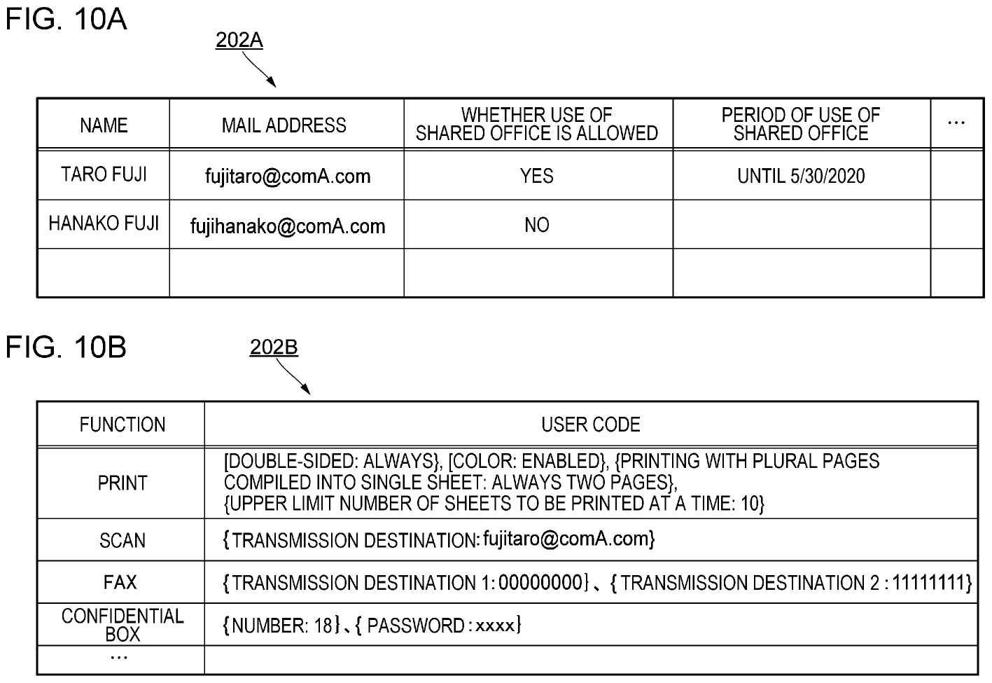

FIGS. 10A and 10B each illustrate an example of data managed by the management server 20. FIG. 10A illustrates an example of data on the user information 202A. FIG. 10B illustrates an example of data on the setting information and policy information 202B stored for each user.

The user information 202A is management information on the users who belong to the company. In the case of FIG. 10A, the user information 202A is composed of the name, the mail address, whether or not the user is allowed to use the shared offices, and the period of use of the shared offices. The period of use of the shared offices is recorded only for users who are permitted to use the shared offices.

While only the date of termination of the period of use of the shared offices is stored in the example of FIG. 10A, the date of start of the period of use may also be stored. In the case where the time of start and the time of termination of the period of use are also managed, such information is stored in connection with the period of use.

Although not illustrated, information that specifies shared offices that are usable is also stored in connection with the users. In the case where the period for which use is allowed is set for each shared office, the period of use is stored for each shared office.

The setting information and policy information 202B indicated in FIG. 10B is information on Taro Fuji. The setting information and policy information 202B indicated in FIG. 10B is constituted of setting information and policy information connected with the functions of the image forming apparatus.

In the case of FIG. 10B, examples of the functions of the image forming apparatus include printing, scanning, faxing, and confidential box. The confidential box is a storage region provided exclusively for a specific user or department. Access to the confidential box is allowed for only authorized users. Other such functions may include a copy function and a job flow function of invoking a sequence of operations to be applied to documents accumulated in the confidential box.

For example, the printing function is connected with setting for double-sided printing, setting for color printing, setting for printing in which a plurality of pages are compiled into a single sheet of paper, and the upper limit of the number of sheets to be printed at a time.

The scanning function is connected with information on the destination for saving of image data optically read from a document. In the case of FIG. 10B, the read image data are to be saved in the management server 20 of the company to which the user belongs, and therefore the term “destination for transmission” is used.

The faxing function is connected with information on the destination for transmission of image data optically read from a document.

The confidential box function is connected with a box number for specifying a storage region and a password.

<Flow of Processing Operation>

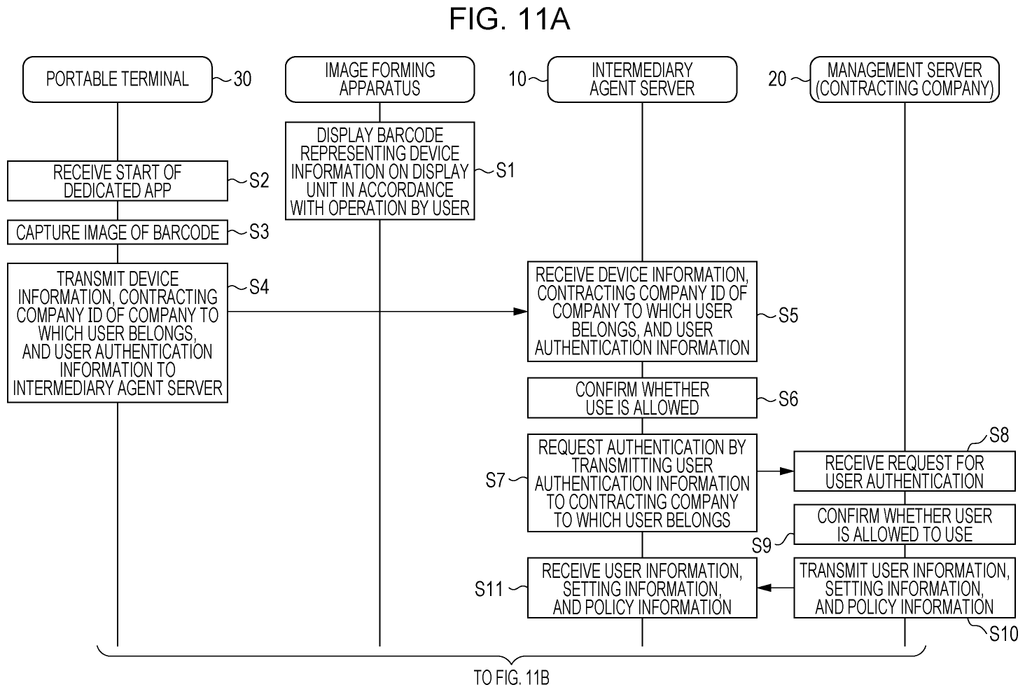

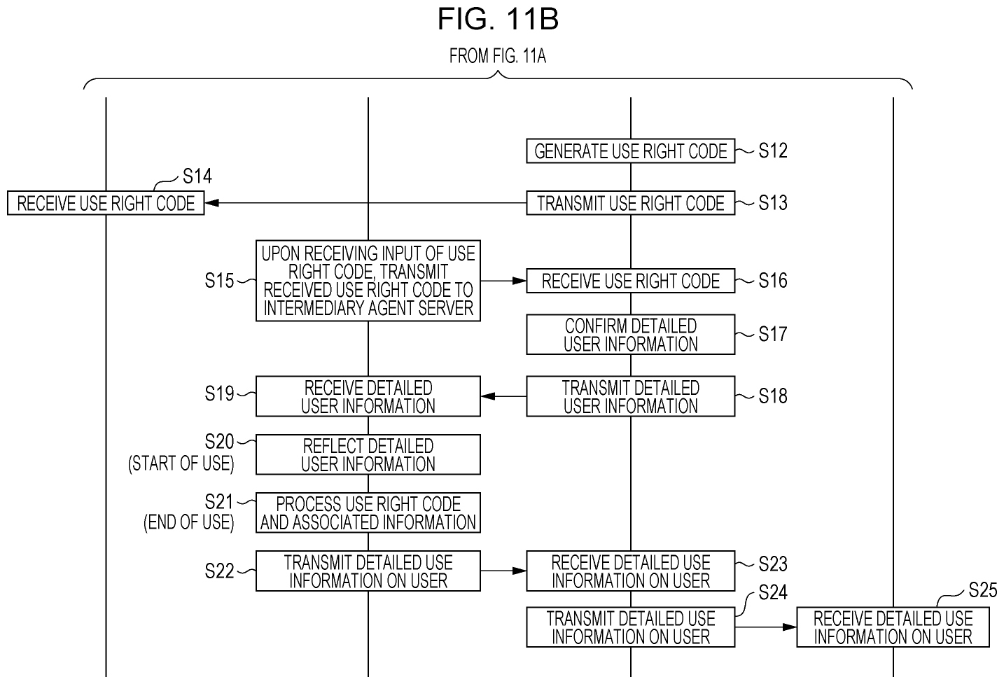

Processing operation of the management system 1 will be described below with reference to FIGS. 11A and 11B to 17.

FIGS. 11A and 11B illustrate the flow of processing operation executed by the management system 1. The symbol “S” in the drawings signifies a step.

A sequence of processing operations is started when a user who uses a shared office operates a touch screen of an image forming apparatus that the user desires to use.

Upon receiving the operation, the image forming apparatus displays, on the display unit 17 (see FIG. 2), a barcode that represents device information in accordance with the operation by the user (step 1). Examples of the device information include a shared office ID and a device ID.

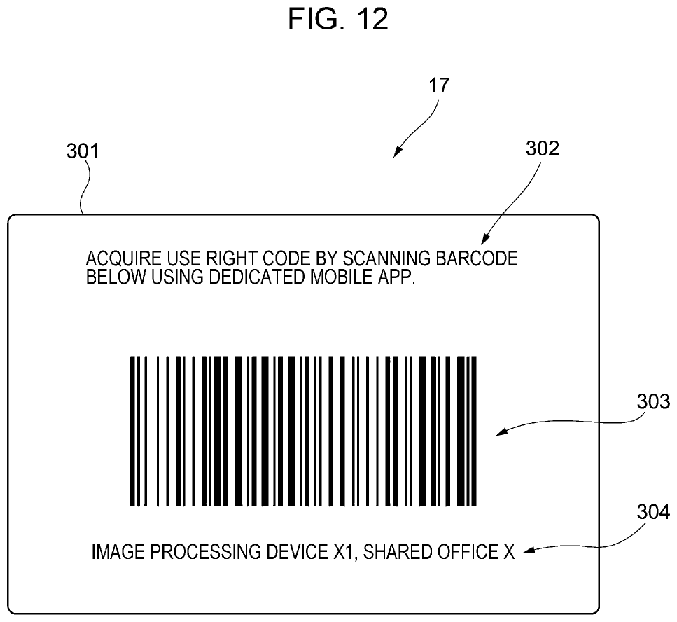

FIG. 12 illustrates an example of a screen 301 displayed on the display unit 17 of the image forming apparatus in the case where the user who desires to use the shared office performs a specific operation. The screen 301 illustrated in FIG. 12 includes a guidance statement 302 about an operation that is requested for the user, a barcode 303, and device information 304.

The guidance statement 302 indicated in FIG. 12 contains the wording “Acquire use right code by scanning barcode below using dedicated mobile app”. Upon seeing this guidance statement 302, the user starts a dedicated app on his/her own portable terminal 30 (see FIG. 1), and reads the barcode. The barcode 303 indicated in FIG. 12 includes a shared office ID and a device ID. A QR Code (registered trademark) may be used to display such information.

The device information 304 indicated in FIG. 12 indicates text information corresponding to the shared office ID and the device ID.

Upon confirming the display, the user starts a dedicated application program (hereinafter referred to as an “app”) on his/her own portable terminal 30. The portable terminal 30 stores the ID (i.e. contracting company ID) of the company to which the user belongs and the user authentication information, for example.

Upon receiving start of the dedicated app (step 2), the portable terminal 30 captures an image of the barcode which is positioned within a capture range by the user (step 3). An image of the barcode is captured using a camera (not illustrated) provided in the portable terminal 30.

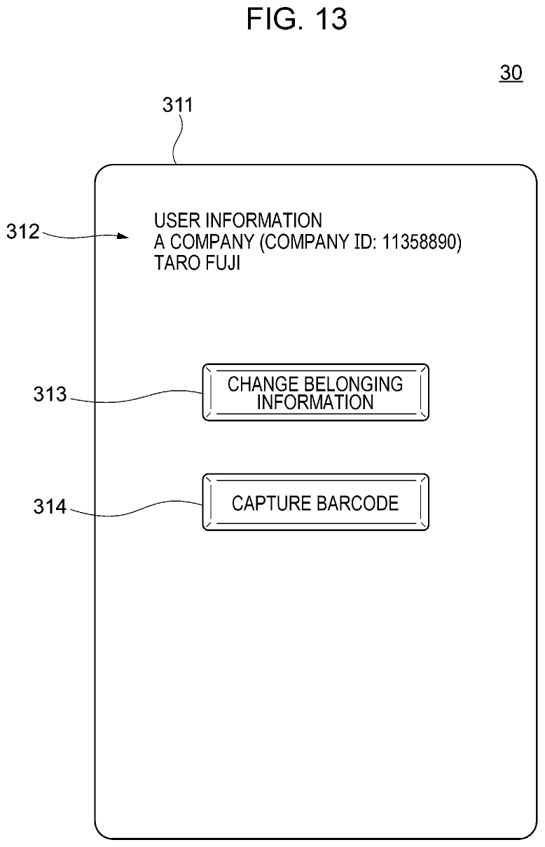

FIG. 13 illustrates an example of a screen 311 displayed on the portable terminal 30 in the case where the user starts the dedicated app. The screen 311 illustrated in FIG. 13 includes user information 312, a button 313 for receiving a change in belonging information, and a barcode capture button 314.

In the case of FIG. 13, the user information 312 includes the name of the user and information on the company to which the user belongs displayed as text. In the case of FIG. 13, the company is A Company whose corporate ID is “11358890”. The user information 312 may also include a mail address.

Such information is changeable by operating the button 313. In addition, the barcode displayed on the display unit 17 of the image forming apparatus may be captured by operating the capture button 314.

When an image of the barcode is captured, the portable terminal 30 transmits, to the intermediary agent server 10, device information read from the captured barcode, the contracting company ID of the company to which the user belongs, and the user authentication information (step 4). The contracting company ID of the company to which the user belongs and the user authentication information are stored in the portable terminal 30.

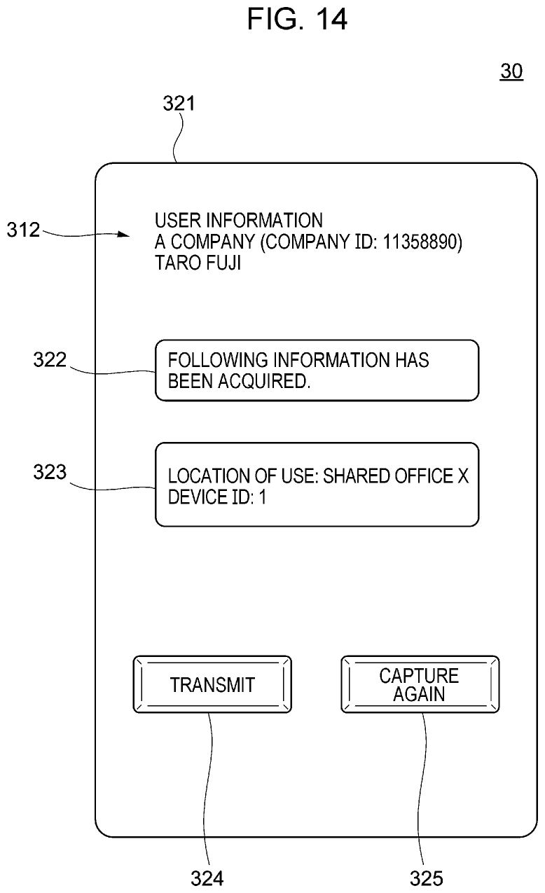

FIG. 14 illustrates an example of a screen 321 displayed on the portable terminal 30 in the case where the barcode is captured. Portions in FIG. 14 corresponding to those in FIG. 13 are denoted by the corresponding reference numerals.

The screen 321 illustrated in FIG. 14 includes the user information 312, a descriptive statement 322 about displayed information, information 323 read from the barcode, a transmit button 324, and a button 325 for capturing the barcode again.

In the case of FIG. 14, the descriptive statement 322 indicates that the information read from the barcode is displayed. In the case of FIG. 14, the information 323 indicates that the location of use is “shared office X”, and that the device ID of the image forming apparatus is “1”.

When the transmit button 324 is operated, the read information 323 is transmitted to the intermediary agent server 10. When the button 325 is operated, the barcode is captured again.

The intermediary agent server 10 receives the device information, the ID (i.e. contracting company ID) of the company to which the user belongs, and the user authentication information from the portable terminal 30 of the user who attempts to use the image forming apparatus in the shared office by way of the Internet (step 5).

Next, the intermediary agent server 10 confirms using the received device information and contracting company ID of the company to which the user belongs whether or not the user is allowed to use the image forming apparatus (6). In other words, the intermediary agent server 10 confirms whether or not there is a contract that allows the user who transmitted such information to use the image forming apparatus displaying the barcode.

In the case where the presence of such a contract is confirmed from the device information and contracting company ID received from the user, the intermediary agent server 10 transmits the user authentication information to the company to which the user belongs to request authentication (step 7).

When a request for authentication of the user is received from the intermediary agent server 10 (step 8), the management server 20 of the company to which the user belongs confirms whether or not the user as the subject of authentication is allowed to use the image forming apparatus (step 9). Specifically, the management server 20 confirms whether the user is an employee of the company, whether the user is allowed to use the shared office, whether there are operational settings for the image forming apparatus, whether operational policy information is set, etc.

In the case where it is confirmed that the user as the subject of authentication is an employee of the company and is allowed to use the shared office, the management server 20 transmits user information, setting information, and policy information to the intermediary agent server 10 (step 10).

The intermediary agent server 10 receives the user information, the setting information, and the policy information from the management server 20 (step 11).

Next, the intermediary agent server 10 generates a use right code on the basis of the received information (step 12), and transmits the generated use right code to the portable terminal 30 which transmitted the information received in step 5 (step 13).

After that, the portable terminal 30 receives the use right code (step 14).

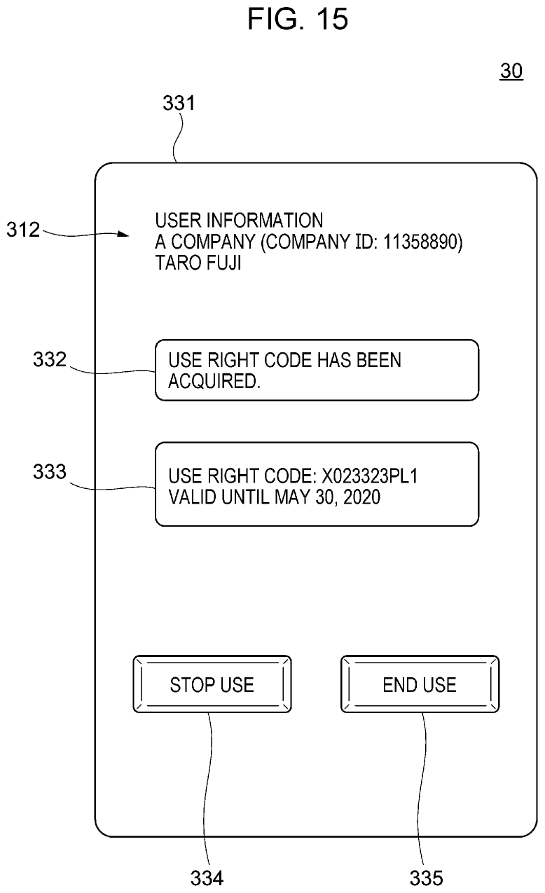

FIG. 15 illustrates an example of a screen 331 displayed in the case where the portable terminal 30 receives the use right code from the intermediary agent server 10. Portions in FIG. 15 corresponding to those in FIG. 14 are denoted by the corresponding reference numerals.

The screen 331 illustrated in FIG. 15 includes the user information 312, a descriptive statement 332 about displayed information, acquired information 333, a use stop button 334, and a use end button 335.

In the case of FIG. 15, the descriptive statement 332 indicates that a use right code has been acquired, and the information 333 indicates the use right code and the last day of a period for which use is allowed.

The use stop button 334 is operated to cancel start of use of the image forming apparatus. The use end button 335 is operated to end use of the image forming apparatus.

Upon confirming the acquisition of the use right code on the screen 331, the user inputs the acquired use right code to the image forming apparatus whose barcode has been read while confirming the screen 331.

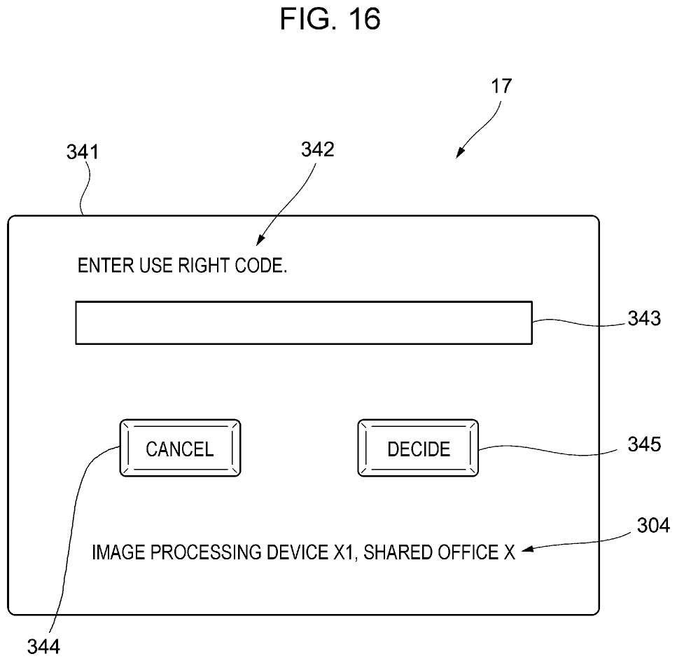

FIG. 16 illustrates an example of a screen 341 displayed on the display unit 17 of the image forming apparatus. Portions in FIG. 16 corresponding to those in FIG. 12 are denoted by the corresponding reference numerals.

The screen 341 illustrated in FIG. 16 includes a guidance statement 342 about an operation that is requested for the user, an input field 343 for the use right code, a button 344 that is used to cancel an operation, a button 345 that is used to decide an operation, and device information 304.

The guidance statement 342 indicated in FIG. 16 contains the wording “Enter use right code”. Upon seeing the guidance statement 342, the user inputs the use right code displayed on his/her own portable terminal 30 to the input field 343.

Upon receiving input of the use right code, the image forming apparatus to be operated transmits the received use right code to the intermediary agent server 10 (step 15). At this time, the image forming apparatus also transmits the device information including the shared office ID and the device ID in addition to the use right code. This transmission secures connection between the user and the image forming apparatus.

The intermediary agent server 10 receives the use right code from the image forming apparatus (step 16). After that, the intermediary agent server 10 determines whether or not the received information matches the device information managed by the intermediary agent server 10 itself or the use right code generated in step 12. In the case where such pieces of information are confirmed to match each other, the intermediary agent server 10 confirms detailed user information including the user information, the setting information, and the policy information associated with the use right code (step 17).

When the confirmation is finished, the intermediary agent server 10 transmits the detailed user information to the image forming apparatus (step 18). Upon receiving the detailed user information (step 19), the image forming apparatus reflects the received detailed user information (step 20). That is, the image forming apparatus stores, in the storage device 15 (see FIG. 2), the name of the user who starts the operation, the mail address, whether or not the user is allowed to use the shared office, the period of use of the shared office, the operational setting information, and the operational policy information. In addition, the image forming apparatus changes setting for the corresponding function to the received setting information or policy information. Consequently, the user who starts the operation becomes able to use setting dedicated to the user himself/herself.

In this manner, the setting information and the policy information is reflected in the image forming apparatus each time the user uses the image forming apparatus even if the manager of the shared office does not perform the work of individually registering, in the image forming apparatus, setting dedicated to each user and given beforehand from the contracting company.

After that, use of the image forming apparatus by the user is started. At this time, the user is enabled to use the image forming apparatus in the shared office using the same setting as that for the image forming apparatus that the user uses at the company to which he/she belongs.

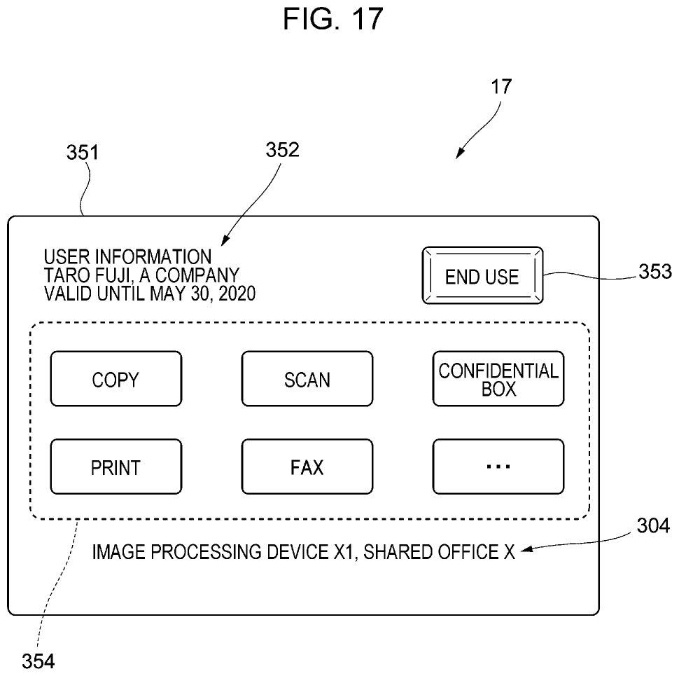

FIG. 17 illustrates an example of a screen 351 displayed on the display unit 17 of the image forming apparatus after the start of use by the user. Portions in FIG. 17 corresponding to those in FIG. 12 are denoted by the corresponding reference numerals.

The screen 351 illustrated in FIG. 17 includes user information 352, a button 353 that is operated to end use of the image forming apparatus, function buttons 354, and the device information 304.

The user information 352 indicated in FIG. 17 indicates information on a period for which the user is allowed to use the image forming apparatus, in addition to the name of the user who is operating the image forming apparatus and information on the company to which the user belongs.

When the user operates one of the function buttons 354, the user is allowed to use a function in which the setting information and policy information received from the intermediary agent server 10 is reflected.

To end use of the image forming apparatus, the user operates the button 353. When the button 353 is operated, the image forming apparatus confirms the period of validity of the use right code, and processes the use right code and the associated information (step 21). In the case where the limit number of times of use is reached or the period of validity expires, the image forming apparatus deletes the use right code and the associated information. In other words, the image forming apparatus holds the use right code and the associated information until the limit number of times of permitted use is reached or while the period of validity remains.

In the case where the company to which the user belongs does not desire that the use right code or the associated information should remain in the image forming apparatus while the user does not use the image forming apparatus, on the other hand, the user information, the setting information, and the policy information connected with the use right code may be deleted each time use by the user is ended.

In any case, the user information, the setting information, and the policy information is present in the image forming apparatus only for a period since the time when the user uses the image forming apparatus in the shared office for the first time until the number of times of use reaches the limit number of times or until the period of validity expires.

After that, the image forming apparatus transmits the detailed use information on the user to the intermediary agent server 10 (step 22). The detailed use information includes information for identifying the user and the image forming apparatus which is used by the user. The detailed use information is deleted after being transmitted to the intermediary agent server 10.

When the detailed use information on the user is received (step 23), the intermediary agent server 10 transmits the detailed use information on the user to the management server 20 of the contracting company to which the user belongs (step 24). Such transmission is executed at intervals set in advance, for example.

The management server 20 of the company to which the user belongs receives the detailed use information on the user (step 25).

<Other Exemplary Embodiments>

While an exemplary embodiment of the present disclosure has been described above, the technical scope of the present disclosure is not limited to the exemplary embodiment discussed earlier. It is apparent from the following claims that a variety of modifications and improvements that may be made to the exemplary embodiment discussed earlier also fall within the technical scope of the present disclosure.

For example, while an image forming apparatus with a plurality of functions is assumed as a device disposed in a shared office and shared by unspecified users in the exemplary embodiment discussed earlier, such a device may be any device that includes a display section and that is connectable to a network. Examples of such a device include a three-dimensional printer that forms a three-dimensional image using three-dimensional data. Other examples include a desktop or laptop computer, a dedicated printer, and a dedicated facsimile. Other examples also include a device that processes an image such as a monitor and a projector. All such devices are examples of a network device.

While the device information on the image forming apparatus is displayed as a barcode in the exemplary embodiment discussed earlier, the device information may be given to the portable terminal 30 using near-field wireless communication such as wireless LAN, near field communication (NFC), and Bluetooth (registered trademark).

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
receive first information for identifying a network device selected to be used by a user and second information for identifying the user, from a terminal of the user, each time the network device is used,
acquire, from a system of a business operator to which the user belongs, operational setting to be applied to the user who is identified by the second information and uses the network device identified by the first information, and
notify the network device of the operational setting.

2. The information processing apparatus according to claim 1,
wherein the processor is configured to acquire, from the system of the business operator, a period for which use of the network device by the user identified by the second information is permitted.

3. The information processing apparatus according to claim 2,
wherein the processor is configured to notify the terminal of the user identified by the second information of the period for which use of the network device is permitted.

4. The information processing apparatus according to claim 1,
wherein the processor is configured to notify the terminal of the user identified by the second information of third information that represents an authority to use the network device in a case where use of the network device identified by the first information is permitted for the user.

5. The information processing apparatus according to claim 4,
wherein the processor is configured to notify the network device identified by the first information of the operational setting to be applied to the user identified by the second information on condition that the third information is received from the network device.

6. The information processing apparatus according to claim 4,
wherein the third information is generated each time permission for use by the user identified by the second information is confirmed.

7. The information processing apparatus according to claim 5,
wherein the third information is generated each time permission for use by the user identified by the second information is confirmed.

8. The information processing apparatus according to claim 1,
wherein the processor is configured to notify the network device identified by the first information of a period for which use of the network device by the user identified by the second information is permitted.

9. The information processing apparatus according to claim 8,
wherein the processor is configured to instruct the network device identified by the first information to delete information on the user identified by the second information and the operational setting after the period for which the use is permitted elapses.

10. The information processing apparatus according to claim 8,
wherein the processor is configured to instruct the network device identified by the first information to delete information on the user identified by the second information and the operational setting each time the use is ended.

11. The information processing apparatus according to claim 1,
wherein the processor is configured to notify the system of the business operator to which the user identified by the second information belongs of a result of use by the user.

12. The information processing apparatus according to claim 11,
wherein the processor is configured to notify the system of the result of use each time use by the user identified by the second information is ended.

13. A network device comprising:
a processor configured to
present, on a display section, information for identifying the network device to a user who desires to use the network device, and
receive operational setting to be applied to the user from an external terminal and set the operational setting to the network device in a case where the user has an authority to use the network device as a result of authentication made by the user with the external terminal using the information for identifying the network device.

14. The network device according to claim 13,
wherein the processor is configured to present, on the display section, information on a period for which use of the network device by the user is permitted.

15. The network device according to claim 14,
wherein the processor is configured to delete information on the user and the operational setting after the period for which use by the user is permitted elapses.

16. The network device according to claim 14,
wherein the processor is configured to delete information on the user and the operational setting each time use by the user is ended.

17. An information processing apparatus comprising:
means for receiving first information for identifying a network device selected to be used by a user and second information for identifying the user from a terminal of the user each time the network device is used,
means for acquiring, from a system of a business operator to which the user belongs, operational setting to be applied to the user who is identified by the second information and uses the network device identified by the first information, and
means for notifying the network device of the operational setting.
